(19) United States
(12) Patent Application Publication
(10) Pub. No.: US 2007/0216872 A1
(43) Pub. Date: Sep. 20, 2007

(54) Two- Stage Projector Architecture

(76) Inventor: Estill Thone Hall JR., Indianapolis, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/594,107

(22) PCT Filed: Mar. 26, 2004
(86) PCT No.: PCT/US04/09100

§ 371 Date: Sep. 25, 2006

(51) Int. Cl. G03B 21/00; G02F 1/1335

(52) U.S. Cl. 353/31; 349/5

(57) ABSTRACT

A light projection system is provided for projecting an image comprising a matrix of light pixels having modulated luminance. The projection system includes a first imager and a second imager having corresponding matrices of pixels. A relay lens system projects the output matrix from the first imager onto the second imager so that the second imager modulates the matrix of modulated light pixels on a pixel by pixel basis. A projection lens system projects the second output matrix onto a screen for viewing. The first imager, the second imager, the relay lens system, and the projection lens system are configured to provide a speed of at least f/2.0.

### FIELD OF THE INVENTION

The present invention relates generally to a microdisplay system using a liquid crystal on silicon (LCOS) imager, and more particularly to a microdisplay system using two sequential LCOS imagers to provide a faster system.

### BACKGROUND OF THE INVENTION

In microdisplay systems, the brightness is determined by the type of system, and by the lamp wattage. Once the fundamental imager technology is determined, one usually only has the lamp wattage as a variable, but the higher the lamp wattage, the shorter the lamp lifetime. This problem is generally solved by increasing the lamp wattage (at the expense of lifetime) or by small incremental improvements to light engine architecture, or component performance. (e.g., improving mirror reflectivity, etc.)

The ability to enhance contrast in an LCOS microdisplay greatly depends upon how efficiently the polarization components can handle light coming from angles far from the “optimum” angle. In order to provide adequate contrast for a viewable image in existing LCOS microdisplay systems, the cone angle, and therefore the speed, of the projection system is limited (i.e., the f-number is high). The f-numbers for existing LCOS projection systems are determined by the largest cone angle that can be handled with acceptable contrast. In the current, state-of-the-art, this is somewhere around f/2.8. A slower system, however, significantly limits the brightness that can be achieved. For example, a system with f/2.8 projects about one-half as much light as a system with f/2.0.

### SUMMARY OF THE INVENTION

This invention uses an imager-to-imager relay architecture to provide greatly enhanced contrast. A portion of the increased contrast is traded off to leave sufficient contrast, but with greatly increase total brightness. In an exemplary embodiment of the present invention, a light projection system having two sequential imagers is provided for projecting an image comprising a matrix of light pixels having modulated luminance, at a speed of about f/2.0. The first imager is configured to modulate a light band on a pixel-by-pixel basis proportional to gray scale values provided for each pixel of the image to produce a first output matrix. A second imager is positioned and configured to receive the first output matrix of modulated pixels of light and modulate the individual modulated pixels of light from the first imager on a pixel-by-pixel basis proportional to a second gray scale value provided for each pixel of the image to produce a second output matrix. A relay lens system projects the first output matrix from the first imager onto the second imager. A projection lens system projects the second output matrix onto a screen.

Various imager-to-imager relay systems have been proposed to improve contrast and decrease contouring. This invention assumes that more than sufficient contrast has been achieved, and trades some of this contrast for significant brightness improvement.

### BRIEF DESCRIPTION OF THE DRAWINGS

The present invention will now be described with reference to the accompanying drawings, of which:

FIG. 1 is a block diagram of an projection architecture for a faster projection system according to an exemplary embodiment of the present invention;

FIG. 2 shows an exemplary relay lens system for a faster projection system according to an exemplary embodiment of the present invention;

FIG. 3 shows an exemplary projection lens system for a faster projection system according to an exemplary embodiment of the present invention; and

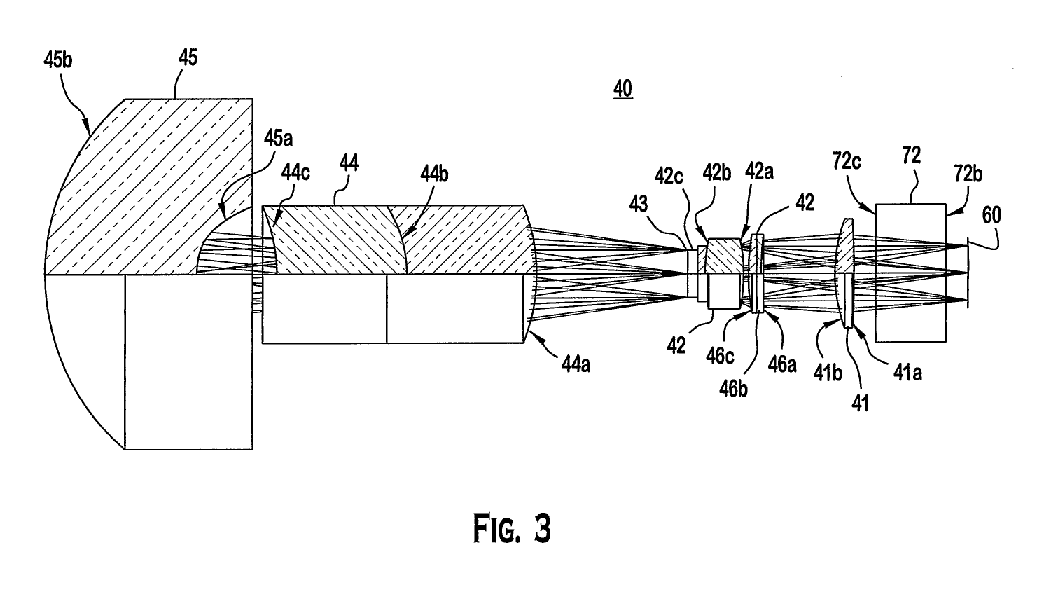

FIG. 4 shows the ensquared energy for a faster projection system according to an exemplary embodiment of the present invention.

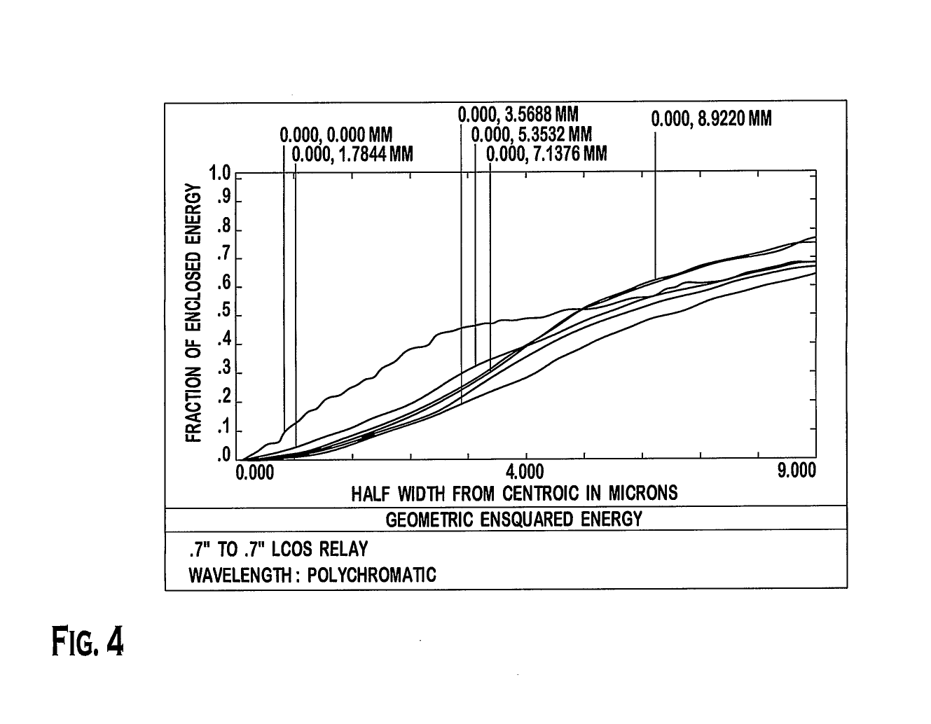

### DETAILED DESCRIPTION OF THE INVENTION

The inventors have determined that the most efficient way of improving brightness for a light engine system is to decrease the f-number (make the optical system faster). In existing Liquid Crystal on Silicon (LCOS) projection systems, the speed of the projection system is limited by the need for high contrast. The ability to provide adequate contrast is strongly a function of how efficiently the polarization components can handle light coming from angles far from the “optimum” angle. Thus, the f-number was determined by the largest cone angle that could be handled with respectable contrast.

In the present invention an imager-to-imager relay architecture provides contrast that is orders of magnitude higher than existing single LCOS architectures, and that therefore, a portion of this increased contrast can be sacrificed to provide a faster system, and thereby increase brightness.

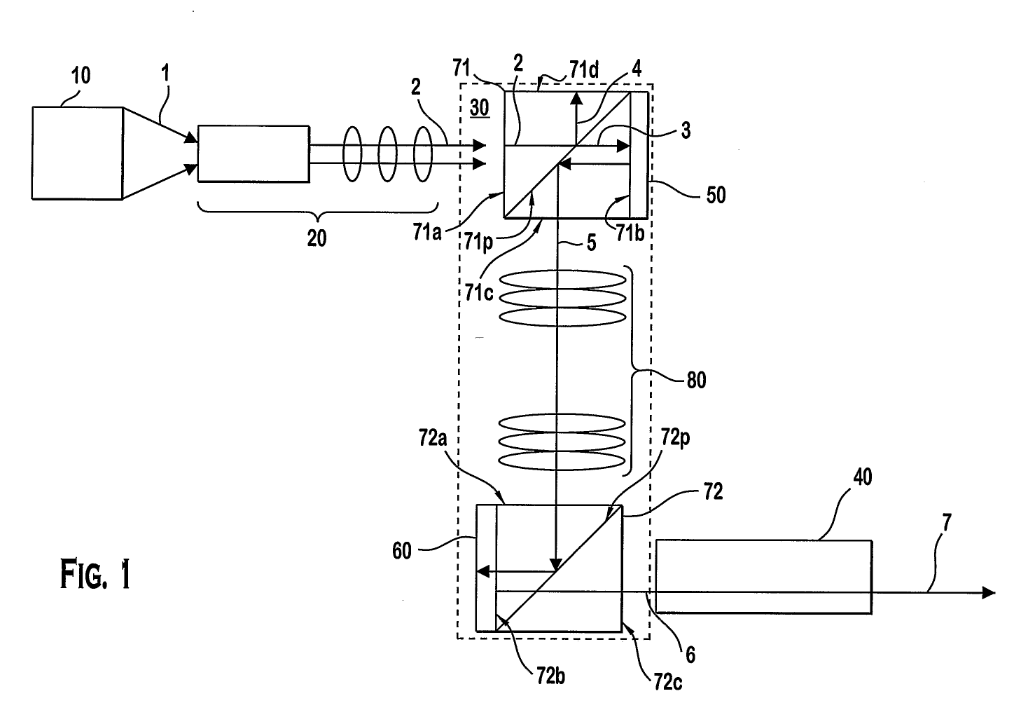

The present invention provides a projection system, such as for a television display, with enhanced contrast ratio and reduced contouring. In an exemplary LCOS system, illustrated in FIG. 1, white light 1 is generated by a lamp 10. Lamp 10 may be any lamp suitable for use in an LCOS system. For example a short-arc mercury lamp may be used. The white light 1 enters an integrator 20, which directs a telecentric beam of white light 1 toward the projection system 30. The white light 1 is then separated into its component red, green, and blue (RGB) bands of light 2. The RGB light 2 may be separated by dichroic mirrors (not shown) and directed into separate red, green, and blue projection systems 30 for modulation. The modulated RGB light 2 is then recombined by a prism assembly (not shown) and projected by a projection lens assembly 40 onto a display screen (not shown).

Alternatively, the white light 1 may be separated into RGB bands of light 2 in the time domain, for example, by a color wheel (not shown), and thus directed one-at-a-time into a single LCOS projection system 30.

An exemplary LCOS projection system 30 is illustrated in FIG. 1, using a two-stage projection architecture according to the present invention. The monochromatic RGB bands of light 2 are sequentially modulated by two different imagers 50, 60 on a pixel-by-pixel basis. The RGB bands of light 2 comprise a p-polarity component 3 and an s-polarity component 4. These RGB bands of light 2 enter a first surface 71a of a first PBS 71 and are polarized by a polarizing surface 71p within the first PBS 71. The polarizing surface 71p allows the P-polarity component 3 of the RGB bands of light 2 to pass through the first PBS 71 to a second surface 71b, while reflecting the s-polarity component 4 at an angle, away from the projection path where it passes out of first PBS 71 through fourth surface 71d. A first imager 50 is disposed beyond the second surface 71b of the first PBS 71 opposite the first face 71a, where the RGB bands of light enter first PBS 71. The p-polarized component 3, which passes through the PBS 71, is therefore incident on the first imager 50.

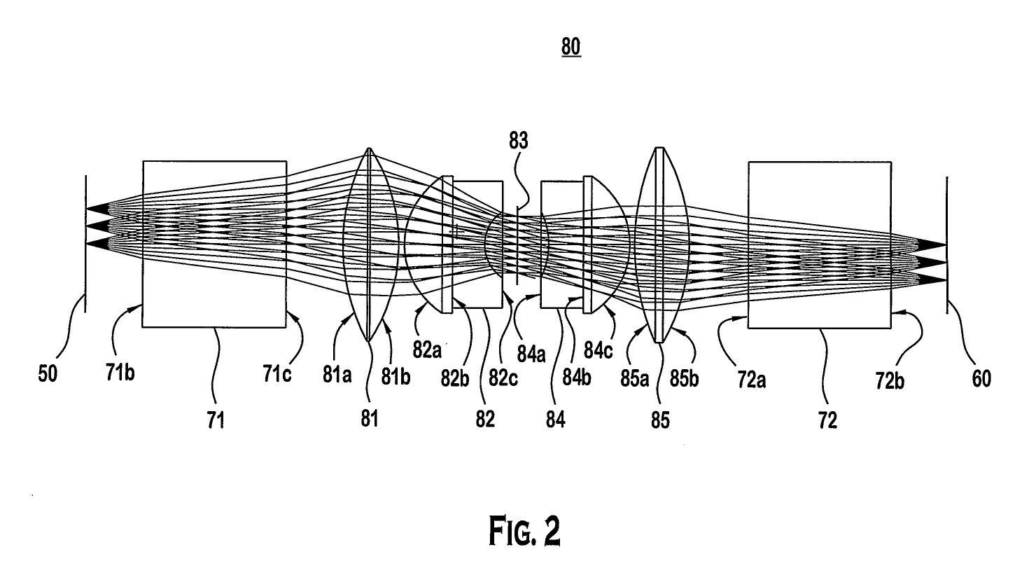

In the exemplary embodiment, illustrated in FIG. 2, first imager 50 is an LCOS imager comprising a matrix of polarized liquid crystals corresponding to the pixels of the display image (not shown). These crystals transmit light according to their orientation, which in turn varies with the strength of an electric field created by a signal provided to the first imager 50. The imager pixels modulate the p-polarized light 3 on a pixel-by-pixel basis proportional to a gray scale value provided to the first imager 50 for each individual pixel. As a result of the modulation of individual pixels, the first imager 50 provides a first light matrix 5, comprising a matrix of pixels or discreet dots of light. First light matrix 5 is an output of modulated s-polarity light reflected from the first imager 50 back through second surface 71b of first PBS 71, where it is reflected by a polarizing surface 71p at an angle out of the first PBS 71 through a third surface 71c. Each pixel of the first light matrix 5 has an intensity or luminance proportional to the individual gray scale value provided for that pixel in first imager 50.

The first light matrix 5 of s-polarized light is reflected by the PBS 71 through a relay lens system 80, which provides 1-to-1 transmission of the first light matrix 5. In an exemplary embodiment, illustrated in FIG. 2, relay lens system 80 comprises a series of aspherical and acromatic lenses configured to provide low distortion of the image being transmitted with a magnification of 1, so that the output of each pixel in the first imager 50 is projected onto a corresponding pixel of the second imager 60.

As shown in FIG. 2, exemplary relay lens system 80 comprises a first aspheric lens 81 and a first acromatic lens 82 between the first PBS 71 and the focal point of the lens system or system stop 83. Between the system stop 83 and the second imager 72, lens system 80 comprises a second acromatic lens 84 and a second aspheric lens 85. First aspheric lens 81 has a first surface 81a and second surface 81b which bend the diverging light pattern from the first PBS 71 into a light pattern converging toward the optical axis of lens system 80. First acromatic lens 82 has a first surface 82a, a second surface 82b, and a third surface 82c, which focus the converging light pattern from the first aspheric lens 81 onto the system stop 83. At the system stop 83, the light pattern inverts and diverges. The second acromatic lens 84, which has a first surface 84a, a second surface 84b, and a third surface 84c, is a mirror image of first acromatic lens 82 (i.e., the same lens turned backward such that first surface 84a of second acromatic lens 84 is equivalent to third surface 82c of first acromatic lens 82 and third surface 84c of second acromatic lens 84 is equivalent to first surface 82a of first acromatic lens 82 ). The surfaces 84a, 84b, and 84c of second acromatic lens 84 distribute the diverging light pattern onto the second aspherical lens 85. The second aspherical lens 85, which has a first surface 85a and a second surface 85b, is a mirror image of the first aspherical lens 81. Surfaces 85a and 85b bend the light pattern to converge to form an inverted image on the second imager 72 that has a one-to-one correspondence to the object or matrix of pixels from the first imager 50. The surfaces of relay lens system 80 are configured to work with the imagers 50, 60 and PBS's 71, 72 to achieve the one-to-one correspondence of the pixels of first imager 50 and second imager 60. A summary of the surfaces of an exemplary two-stage projection system 30 are provided in Table 1, and aspheric coefficients for surfaces 81a, 81b, 85a, and 85b are provided in Table 2. Various modifications can be made to this exemplary projection system based on such factors as: cost, size, luminance levels, and the other design factors. Because relay lens system 80 (i.e., acromatic lenses 82 and 84 are equivalent and aspherical lenses 81 and 85 are equivalent), fewer unique parts are required providing manufacturing efficiencies and reduced cost.

TABLE 1
(dimensions in millimeters)

| Surface | Type | Radius | Thickness | Glass | Diameter | Conic |
|---|---|---|---|---|---|---|
| 50 | Standard | Infinity | 11.25436 | | 17.844 | 0 |
| 71b | Standard | Infinity | 28 | SF2 | 23.08323 | 0 |
| 71c | Standard | Infinity | 11.44304 | | 30.88921 | 0 |
| 81a | Evenasph | 35.56118 | 10.81073 | BAK2 | 38.49861 | −1.30049 |
| 81b | Evenasph | −35.32586 | 0.9976328 | | 38.47126 | −2.663849 |
| 82a | Standard | 16.26613 | 9.167512 | BAK2 | 27.61794 | 0 |
| 82b | Evenasph | 145.0546 | 6.761668 | SF15 | 24.98725 | −1.252013e+050 |
| 82c | Evenasph | 10.7194 | 6.173531 | | 13.23529 | 0.3316497 |
| 83 | Standard | Infinity | 6.173531 | | 13.73357 | 0 |
| 84a | Evenasph | −10.7194 | 6.761668 | SF15 | 13.23529 | 0.3316497 |
| 84b | Evenasph | −145.0546 | 9.167512 | BAK2 | 24.98725 | −1.252013e+050 |
| 84c | Standard | −16.26613 | 0.9976328 | | 27.61794 | 0 |
| 85a | Evenasph | 35.32586 | 10.81073 | BAK2 | 38.47126 | −2.663849 |
| 85b | Evenasph | −35.56118 | 11.44304 | | 38.49861 | −1.30049 |
| 72a | Standard | Infinity | 28 | SF2 | 30.88921 | 0 |
| 72b | Standard | Infinity | 11.25436 | | 23.08323 | 0 |
| 60 | Standard | Infinity | | | 17.844 | 0 |

TABLE 2

| Coefficient | Surface 81a: | Surface 81b: | Surface 82b: | Surface 82c: |
|---|---|---|---|---|
| on: | Evenasph | Evenasph | Evenasph | Evenasph |
| r² | 0.00065991664 | −0.0012422958 | 0.0043642077 | 0.013992568 |
| r⁴ | −5.3845494e−006 | −3.4712368e−006 | −8.4982715e−006 | 8.9149523e−005 |
| r⁶ | 2.0005042e−009 | 1.0944971e−009 | −4.6134557e−008 | 9.2418363e−007 |
| r⁸ | −1.2552168e−011 | 1.7910339e−012 | 1.9461602e−010 | −1.4097758e−009 |
| r¹⁰ | 4.7280067e−014 | 2.2512778e−014 | 1.425742e−012 | −5.7462821e−011 |
| r¹² | 1.8540132e−016 | 2.8401724e−017 | −6.7183867e−015 | 3.451586e−012 |
| r¹⁴ | 7.7119604e−020 | 5.947849e−019 | −8.0321604e−017 | 3.5656137e−014 |
| r¹⁶ | −1.2711641e−021 | −1.7385716e−021 | 3.0712524e−019 | −6.7281845e−016 |
| Coefficient | Surface 84a: | Surface 84b: | Surface 85a: | Surface 85b: |
| on: | Evenasph | Evenasph | Evenasph | Evenasph |
| r² | 0.013992568 | 0.0043642077 | −0.0012422958 | 0.00065991664 |
| r⁴ | 8.9149523e−005 | −8.4982715e−006 | −3.4712368e−006 | −5.3845494e−006 |
| r⁶ | 9.2418363e−007 | −4.6134557e−008 | 1.0944971e−009 | 2.0005042e−009 |
| r⁸ | −1.4097758e−009 | 1.9461602e−010 | 1.7910339e−012 | −1.2552168e−011 |
| r¹⁰ | −5.7462821e−011 | 1.425742e−012 | 2.2512778e−014 | 4.7280067e−014 |
| r¹² | 3.451586e−012 | −6.7183867e−015 | 2.8401724e−017 | 1.8540132e−016 |
| r¹⁴ | 3.5656137e−014 | −8.0321604e−017 | 5.947849e−019 | 7.7119604e−020 |
| r¹⁶ | −6.7281845e−016 | 3.0712524e−019 | −1.7385716e−021 | −1.2711641e−021 |

After the first light matrix 5 leaves the relay lens system 80, it enters into a second PBS 72 through a first surface 72a. Second PBS 72 has a polarizing surface 72p that reflects the s-polarity first light matrix 5 through a second surface 72b onto a second imager 60. In the exemplary embodiment, illustrated in FIG. 2, second imager 60 is an LCOS imager which modulates the previously modulated first light matrix 5 on a pixel-by-pixel basis proportional to a gray scale value provided to the second imager 60 for each individual pixel. The pixels of the second imager 60 correspond on a one-for-one basis with the pixels of the first imager 50 and with the pixels of the display image. Thus, the input of a particular pixel (i,j) to the second imager 60 is the output from corresponding pixel (i,j) of the first imager 50.

The second imager 60 then produces an output matrix 6 of p-polarity light. Each pixel of light in the output matrix 6 is modulated in intensity by a gray scale value provided to the imager for that pixel of the second imager 60. Thus a specific pixel of the output matrix 6 (i,j) would have an intensity proportional to both the gray scale value for its corresponding pixel (i,j), in the first imager and its corresponding pixel (i,j)₂ in the second imager 60.

The light output L of a particular pixel (i,j) is given by the product of the light incident on the given pixel of first imager 50, the gray scale value selected for the given pixel at first imager 50, and the gray scale value selected at second imager 60:
L=L0×G1×G2

L0 is a constant for a given pixel (being a function of the lamp 10, and the illumination system.) Thus, the light output L is actually determined primarily by the gray scale values selected for this pixel on each imager 50, 60. For example, normalizing the gray scales to 1 maximum and assuming each imager has a very modest contrast ratio of 200:1, then the bright state of a pixel (i,j) is 1, and the dark state of pixel (i,j) is 1/200 (not zero, because of leakage). Thus, the two stage projector architecture has a luminance range of 40,000:1.
Lmax=1×1=1;
Lmin=0.005×0.005=0.000025

The luminance range defined by these limits gives a contrast ratio of 1/0.000025:1, or 40,000:1. Importantly, the dark state luminance for the exemplary two-stage projector architecture would be only a forty-thousandth of the luminance of the bright state, rather than one two-hundredth of the bright state if the hypothetical imager were used in an existing single imager architecture. As will be understood by those skilled in the art, an imager with a lower contrast ratio can be provided for a considerably lower cost than an imager with a higher contrast ratio. Thus, a two-stage projection system using two imagers with a contrast ratio of 200:1 will provide a contrast ratio of 40,000:1, while a single-stage projection system using a much more expensive imager with a 500:1 ratio will only provide a 500:1 contrast. Also, a two-stage projection system with one imager having a 500:1 contrast ratio and an inexpensive imager with a 200:1 ratio will have a system contrast ratio of 100,000:1. Accordingly, a cost/performance trade-off can be performed to create an optimum projection system.

Output matrix 6 enters the second PBS 72 through second surface 72b, and since it comprises p-polarity light, it passes through polarizing surface 72p and out of the second PBS 72 through third surface 72c. After output matrix 6 leaves the second PBS 72, it enters the projection lens system 40, which projects a display image 7 onto a screen (not shown) for viewing.

The projection lens system 40 comprises, sequentially, an first acrylic aspheric lens 41 having first surface 41a and second surface 41b, a first acromat 42 having first surface 42a second surface 42b and third surface 42c, a second acromat 46 having first surface 46a second surface 46b and third surface 46c, a system stop 43, a third acromat 44 having first surface 44a second surface 44b and third surface 44c, and a second acrylic aspheric lens 45 having first surface 45a and second surface 45b. The surface data for an exemplary projection lens system is provided in Table 3, and asymmetric coefficients for surfaces 41a, 41b, 46a, 46b, 46c, 42a, 42b, 42c, 44a, 44b, 44c, 45a and 45b are provided in Table 4.

TABLE 3

| Surface | Type | Radius | Thickness | Glass | Diameter | Conic |
|---|---|---|---|---|---|---|
| Object | Standard | | 800 | | 1100.002 | — |
| 45b | Evenasph | 42.39552 | 4 | Acrylic | 88.71621 | −0.1319231 |
| 45a | Evenasph | 11.64735 | 26.92774 | | 35.83185 | −0.5933635 |
| 44c | Evenasph | −51.0447 | 34.29783 | SF14 | 33.01822 | 1.383886 |
| 44b | Evenasph | −27.62334 | 30.4375 | BALF4 | 30.3389 | −2.065034 |
| 44a | Evenasph | −37.65741 | 16.60473 | | 25.32361 | −1.043163 |
| 43 | Standard | Infinity | 1.353178 | | 13.83615 | 0 |
| 42c | Evenasph | −64.86398 | 10.32941 | SF15 | 14.04195 | 28.33283 |
| 42b | Evenasph | 19.21479 | 7.70906 | BAK1 | 14.92938 | −3.577222 |
| 42a | Evenasph | −36.89524 | 6.067934 | | 17.17366 | 4.081486 |
| 46c | Evenasph | 40.60899 | 3.035341 | BALF4 | 20.89858 | −7.351886 |
| 46b | Evenasph | −126.628 | 0.995876 | SK5 | 21.03055 | −3.956978e+044 |
| 46a | Evenasph | 104.7318 | 9.191248 | | 21.34706 | −107.7969 |
| 41b | Evenasph | 35.45853 | 4.067036 | SK18A | 25.11121 | −0.5186667 |
| 41a | Evenasph | −84.08703 | 4.597553 | | 25.10238 | −45.36996 |
| 72c | Standard | Infinity | 22 | SF2 | 28 | 0 |
| 72b | Standard | Infinity | 3.811 | | 28 | 0 |
| 60 | Standard | Infinity | | | 17.78 | 0 |

TABLE 4

| Coefficient | Surface 45b: | Surface 45a: | Surface 44c: | Surface 44b: |
|---|---|---|---|---|
| on: | Evenasph | Evenasph | Evenasph | Evenasph |
| r² | 0.0015430893 | 0.00073426149 | −0.00068476382 | 0.0019616462 |
| r⁴ | −9.0554125e−008 | −4.2689394e−007 | −8.0066157e−007 | −4.9142658e−007 |
| r⁶ | 1.1016311e−010 | −1.6076735e−009 | 2.1154267e−009 | −7.5860483e−010 |
| r⁸ | −4.0462201e−014 | 3.6006855e−011 | −3.0498299e−012 | 5.3444622e−011 |
| r¹⁰ | −1.8108954e−017 | 1.8489003e−014 | −1.7231292e−014 | 2.6033257e−013 |
| r¹² | 7.6705308e−021 | −1.6005344e−016 | −1.0107579e−016 | −2.0335819e−016 |
| r¹⁴ | −6.5460455e−024 | −2.8486861e−018 | 2.2269027e−020 | −3.959941e−018 |
| r¹⁶ | −1.0120697e−027 | 7.250466e−021 | 4.2801755e−022 | 1.1780701e−020 |
| Coefficient | Surface 44a: | Surface 42c: | Surface 42b: | Surface 42a: |
| on: | Evenasph | Evenasph | Evenasph | Evenasph |
| r² | −0.00026710115 | 0.00014353164 | −0.00084052475 | 3.1622093e−005 |
| r⁴ | −2.262906e−006 | −2.8246572e−006 | 3.3003174e−006 | −4.7258841e−007 |
| r⁶ | 8.4359621e−009 | −1.2621363e−007 | −4.1120483e−007 | −2.4525873e−008 |
| r⁸ | −5.2731051e−012 | −6.5675869e−010 | 3.4468954e−010 | −3.5551977e−010 |
| r¹⁰ | −3.0187548e−013 | 1.9989787e−011 | 1.2138925e−010 | −1.0246971e−011 |
| r¹² | −2.4280998e−014 | 1.0114703e−012 | 2.9964397e−012 | −4.4126936e−014 |
| r¹⁴ | 2.9496681e−016 | 1.9059417e−014 | 2.9627533e−014 | −1.2226439e−015 |
| r¹⁶ | −9.4435261e−019 | −5.1333477e−016 | −6.4729014e−016 | −4.3408799e−018 |

| Coefficient | Surface 46c: | Surface 46b: | Surface 46a: | Surface 41b: | Surface 41a: |
|---|---|---|---|---|---|
| on: | Evenasph | Evenasph | Evenasph | Evenasph | Evenasph |
| r² | −2.7936589e−005 | 0.0029096902 | 3.3646012e−005 | 5.5114256e−005 | −0.00015744998 |
| r⁴ | 5.6123266e−008 | −5.5067532e−005 | −2.8769359e−007 | −1.0429628e−007 | 1.3816067e−006 |
| r⁶ | −5.5824457e−009 | 6.1739225e−007 | −2.26463e−008 | 5.2740407e−009 | 9.7864363e−009 |
| r⁸ | −1.0116282e−010 | −1.3801794e−008 | 1.504908e−010 | 8.2261322e−011 | 9.018886e−012 |
| r¹⁰ | −2.1520884e−013 | −6.7946187e−011 | 1.1589629e−012 | 4.421393e−013 | 4.363313e−013 |
| r¹² | 2.8803977e−015 | −4.3795707e−013 | 3.3012115e−015 | −9.4547137e−017 | −1.243171e−015 |
| r¹⁴ | 4.3812636e−017 | 4.9048857e−015 | −3.5758813e−018 | −2.6613864e−017 | −6.4129403e−017 |
| r¹⁶ | −1.1209548e−018 | 7.4588354e−017 | 3.7135886e−020 | −2.9175389e−019 | −6.7898945e−020 |

By trading off some of the increased contrast provided by the two-stage imager architecture, the exemplary relay lens system 80 and projection lens system 40 can operate at a speed of f/2.0 with an ensquared energy of greater than 60 percent at a half-width of 9 microns. That is to say, greater than 60 percent of the energy from a single pixel is projected into a square having a half-width of 9 microns. Because each pixel of the projected image is modulated by both the first and second imagers, the projection system can provide a contrast greater than the contrast of an individual imager while providing a speed of at least f/2.0, thereby greatly enhancing brightness of the projected image.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A light projection system for projecting an image comprising a matrix of light pixels having modulated luminance, the projection system comprising:
a first imager configured to modulate a light band on a pixel-by-pixel basis proportional to gray scale values provided for each pixel of the image to produce a first output matrix;
a second imager positioned and configured to receive the first output matrix of modulated pixels of light and modulate the individual modulated pixels of light from said first imager on a pixel-by-pixel basis proportional to a second gray scale value provided for each pixel of said image to produce a second output matrix;
a relay lens system for projecting the first output matrix from the first imager onto the second imager; and
a projection lens system for projecting the second output matrix onto a screen;
wherein the first imager, the second imager, the relay lens system, and the projection lens system are configured to provide a speed of at least about f/2.0.

2. The light projection system of claim 1 wherein the relay lens system is symmetrical.

3. The light projection system of claim 2 wherein the relay lens system comprises a system stop having two acromatic lenses adjacent the system stop and a acrylic asymmetric lens at the beginning and the end of the relay lens system.

4. The light projection system of claim 1 wherein the relay lens system projects greater than 60 percent of the energy from a particular pixel within a square having a 9 micron half width.

5. The light projection system of claim 1 wherein the projection lens system comprises, sequentially, an acrylic asymmetric lens, first and second acromatic lenses, a system stop, a third acromatic lens and a second acrylic asymmetric lens.

6. The light projection system of claim 5 wherein the first, second, and third acromatic lenses each have at least one asymmetric surface.

7. The light projection system of claim 6 wherein the first and second acromatic lenses each have three asymmetric surfaces.

8. The light projection system of claim 1 wherein both said first imager and said second imager are Liquid Crystal on Silicon (LCOS) imagers.

9. The light projection system of claim 8 further comprising at least one polarizing beam splitter, wherein said first imager is an LCOS imager and said polarizing beam splitter provides polarized light to said first imager.

10. An image projection system comprising a first imager and a second imager, each of said first and second imagers comprising a corresponding matrix of pixels configured to provide a light output modulated proportional to a gray scale value provided for each pixel, said projection system being configured such that a modulated output from a particular pixel of said first imager is projected onto a corresponding pixel of said second imager by a relay lens system; whereby the light output of a particular pixel of said second imager is proportional to both the gray scale value provided for that pixel and the gray scale value provided for the corresponding pixel of said first imager, the output of said second imager being projected onto a screen by a projection lens system, wherein the said image projection system is configured to have a speed of at least f/2.0.

11. The image projection system of claim 10 wherein the contrast ratio of the image projection system is greater than the contrast ratio of either the first imager or the second imager, individually.

12. The image projection system of claim 11 wherein the relay lens system is symmetrical.

13. The image projection system of claim 12 wherein the relay lens system comprises a system stop having two acromatic lenses adjacent the system stop and a acrylic asymmetric lens at the beginning and the end of the relay lens system.

14. The image projection system of claim 11 wherein the relay lens system projects greater than 60 percent of the energy from a particular pixel within a square having a 9 micron half width.

15. The image projection system of claim 11 wherein the projection lens system comprises, sequentially, an acrylic asymmetric lens, first and second acromatic lenses, a system stop, a third acromatic lens and a second acrylic asymmetric lens.

16. The image projection system of claim 15 wherein the first, second, and third acromatic lenses each have at least one asymmetric surface.

17. The image projection system of claim 16 wherein the first and second acromatic lenses each have three asymmetric surfaces.

18. The image projection system of claim 11 wherein both said first imager and said second imager are Liquid Crystal on Silicon (LCOS) imagers.
